(19) United States
(12) Patent Application Publication
(10) Pub. No.: US 2022/0333407 A1
(43) Pub. Date: Oct. 20, 2022

(54) Safety Switch with Guard Locking

(71) Applicant: Pilz GmbH & Co. KG, Ostfildern (DE)

(72) Inventors: Joachim Rink, Ostfildern (DE); Roger Loop, Bad Ragaz (CH); Andreas Veit, Ostfildern (DE)

(21) Appl. No.: 17/724,283

(22) Filed: Apr. 19, 2022

(30) Foreign Application Priority Data
Apr. 20, 2021 (DE) 10 2021 109 993.5

(51) Int. Cl. E05B 17/22

(52) U.S. Cl. CPC E05B 17/22; F16P 3/08

(57) ABSTRACT

A safety switch includes a movably mounted locking bolt configured to lock an actuator in a defined locking position relative to the safety switch. The safety switch includes a movably mounted locking bulkhead movable between a first position and a second position. The locking bulkhead is configured to fix the movably mounted locking bolt in the second position via a positive fit.

### CROSS-REFERENCE TO RELATED APPLICATIONS

This application claims priority to German Application No. 10 2021 109 993.5 filed Apr. 20, 2021, the entire disclosure of which is incorporated by reference.

### FIELD

The present disclosure relates to a safety switch and more particularly to a safety switching arrangement including a safety switch and an actuator.

### BACKGROUND

Safety switches and corresponding safety switching arrangements are used in safety technology to reduce risks posed to persons by machines and technical systems to an acceptable level. Typically, such safety switching arrangements are used to secure access to a hazardous area, for example in conjunction with a safety door that acts as a separating protective device to secure access to the hazardous area. In such a case, the safety switch only enables operation of a hazardous system within the hazardous area if the safety switching arrangement can ensure that the safety door is properly locked. The system can be enabled via a safety controller that is coupled to the safety switching arrangement and that receives corresponding safety-relevant control signals from the safety switching arrangement.

Safety switching arrangements of this type are subject to normative regulations that specify a defined fault safety of the safety switching arrangement. The required fault safety can be achieved by additional, safety-related devices of the safety switching arrangement. For example, a transmitter and a receiver arranged on the actuator and the safety switch respectively can interact in such a way that they ensure the presence of the actuator in a defined locking position relative to the safety switch.

In addition to the monitoring of the interlocking, a safety switching arrangement of the type mentioned can also be provided with a guard locking.

The guard locking not only monitors a position of a safety-relevant moving component, but also locks it in a defined position. Such a guard locking is known, for example, from DE 10 2009 041 101 A1 or WO 2016/058718 A1. The guard locking described therein has a guard locking bolt that can be moved between a release position and a locking position by means of a rotary drive, wherein the guard locking bolt and the drive are kinematically coupled to one another via a transmission device.

Another form of guard locking is described in EP 3 474 304 A1, which shows a safety switch with a small and compact design. The safety switch according to EP 3 474 304 A1 does not have a locking bolt. Rather, a locking unit is provided in which a locking element in the locking position projects into an opening of the locking unit to reduce the size thereof. An actuator whose forward end has a cross-sectional area larger than this reduced opening, but smaller than the opening alone, can thus be held in the locking unit. The locking element can be moved against an actuating force so that the actuator can pass through the opening, wherein as soon as the actuator is inserted in its locking position, the actuating force transfers the locking element back into the locking position and fixes the actuator. An additional locking unit can be used to lock the locking element so that it can no longer be moved against the actuating force.

The guard locking shown in DE 10 2009 041 101 A1 or WO 2016/058718 A1 has the disadvantage that the bolt is always kinematically coupled to the respective drive and therefore a force acting on the bolt is also transferred to the drive. The device according to EP 3 474 304 A1, on the other hand, decouples the locking element and guard locking, but is limited to certain actuator shapes.

### SUMMARY

It is an object to provide a safety switch that allows guard locking via a bolt. Furthermore, it is an object to provide a safety switch that is of small and compact design. Yet further, it is an object to provide a safety switch that enables guard locking in an effective, safe and energy-saving manner.

According to an aspect of the present disclosure, there is provided a safety switch comprising: a movably mounted locking bolt configured to lock an actuator in a defined locking position relative to the safety switch, and a movably mounted locking bulkhead movable between a first position and a second position, wherein the locking bulkhead is configured to fix the movably mounted locking bolt in the second position via a positive fit.

It is thus an idea of the present invention to provide a safety switch with a locking bolt that can be locked via a movable locking bulkhead. Via a positive fit (form closure) in the second position, the locking bulkhead blocks a movement of the locking bolt and absorbs forces acting on the locking bolt. Forces on the locking bolt, which arise, for example, when trying to open a safety door against the guard locking, can thereby be transferred to the structure of the safety switch, in particular to the housing, without these forces being transferred to an actuating element of the bolt or a drive of the locking bulkhead. Thereby, a drive can be designed for a lower load and operated with less energy, which means that the safety switch can be designed to be smaller, more compact and less expensive overall.

Since the locking is done by a bolt, there are many possibilities for the design of a corresponding actuator or the way an actuator can be combined with the safety switch. The shape of the actuator need only be such that the bolt can engage with it, and an angle at which the actuator approaches the safety switch radially to the bolt can be any. In addition to the smaller and more compact design, a safety switching arrangement consisting of safety switch and actuator can also be used more flexibly in this way.

The structural separation of the bolt for the guard locking and its locking by the bulkhead also has the advantage that both devices only need to be designed for their respective purpose and can therefore be designed particularly effectively.

In various implementations, the locking bolt may be mounted in a guide body having a recess through which the locking bulkhead is movable in the guide body, and wherein the positive fit is formed between the locking bulkhead and the guide body.

The locking bulkhead can thus be pushed into the guide body of the locking bolt to lock the locking bolt. A force acting on the locking bulkhead via the bolt is transferred through the locking bulkhead to the guide body and thus to a structural element of the safety switch. Thereby, a drive of the bolt as well as a drive of the locking bulkhead can be decoupled from this force.

For a positive fit with the guide body of the locking bolt, the use of a very short bulkhead is sufficient, which only has to move a short distance from the first position to the second position. This also allows a drive unit for the locking bulkhead to be designed in a simple and compact manner.

In a further refinement, the safety switch further comprises a transfer element configured to move the locking bulkhead transversely, in particular perpendicularly, to the longitudinal direction of the transfer element from the first position to the second position during a movement extending along a longitudinal direction of the transfer element.

Via the transfer element, it is possible to perform a lateral movement for setting the bulkhead, which can be substantially parallel to the movement of the locking bolt. Thereby, it possible for the safety switch to extend essentially in a longitudinal direction of the locking bolt, which enables a narrow design of the safety switch. The transfer element further enables a drive of the locking bulkhead to be decoupled from the locking bulkhead. In other words, the transfer element and the locking bulkhead may be arranged so that a force acting on the locking bulkhead is not transferred to a drive of the transfer element.

In a further refinement, the transfer element may include a first projection that rises in a first direction transverse to the longitudinal direction of the transfer element and a second projection that rises in a second direction opposite the first direction and that is offset in the longitudinal direction relative to the first projection.

Via the projections, a lifting and lowering movement of the locking bulkhead transverse to the longitudinal direction of the transfer element can be achieved in a simple manner without the need for further components. At the same time, this type of force redirection makes it possible to implement force decoupling in a simple manner.

In a further refinement, the safety switch may further comprise an actuator configured to move the locking bulkhead from the first position to the second position.

The actuator allows for controlled guard locking of the safety switch. Due to the short distance that a locking bulkhead described here must travel to lock the bolt, the drive for the bulkhead can be designed to be very simple, small and energy-saving.

In a further refinement, the drive may be an electromechanical actuator, in particular a linear solenoid, which is configured to perform a first linear movement along a defined direction of movement.

The drive can thus be a simple lifting device, which can be designed particularly simple if only a small stroke is to be exerted. This is possible in the present case due to the corresponding design of the locking bulkhead

In a further refinement, the locking bolt can be configured to perform a second linear movement along the defined direction of movement.

According to this refinement, the directions of movement of the bolt and the drive thus correspond. Thereby, it is possible for the safety switch to extend essentially in a longitudinal direction and thus be as narrow as possible.

In further refinement, the locking bolt and the drive can be force decoupled.

This refinement allows for economical and simple drive, since the drive does not have to compensate for locking forces acting on the locking bolt, as these are decoupled via the positive fit.

In a further refinement, the safety switch may include an actuator with an actuating force that biases the locking bolt into a pre-centering position.

According to this refinement, the safety switch has a pre-centering. Pre-centering means that an actuator is held in a position suitable for locking without already being locked. The pre-centering allows that for the actual locking the locking bolt itself does not have to be moved again, because it is already in a locking position. For final locking, only movement of the locking bolt against the actuating force must be prevented.

In a further refinement, the safety switch may further comprise an additional unlocking means for moving the locking bulkhead from the first position to the second position.

The additional unlocking means can serve as an auxiliary unlocking device and enable manual unlocking. It is also conceivable to upgrade the auxiliary release to an emergency release. The additional unlocking device can also be set up to move the locking bulkhead only. Auxiliary or emergency unlocking can thus be implemented in a simple manner.

In a further refinement, the safety switch may further comprise a reader configured to read signals from a corresponding transponder of the actuator when the actuator is in the defined locking position.

The position of the actuator can be easily verified via a transponder contained in the actuator. The transponder/reader combination can ensure compliance with the normative requirements for a safety switch as an additional safe device. Since the actuator can be configured flexibly according to the embodiment of the invention, the transponder/reader unit combination can also be designed variably.

In a further refinement, the safety switch may further comprise a receptacle into which the actuator is insertable to assume the defined locking position, wherein the receptacle has an opening angle of 180° at which the actuator is insertable into the receptacle.

By allowing an actuator to be fed to the safety switch at a 180° angle, the safety switching arrangement can be designed flexibly and the safety switch can be arranged in different orientations to the actuator.

It goes without saying that the features mentioned above and those to be explained below can be used not only in the combination indicated in each case, but also in other combinations or on their own, without leaving the scope of the present invention.

### BRIEF DESCRIPTION OF THE DRAWINGS

Embodiments of the invention are shown in the drawings and are explained in more detail in the following description.

FIG. 1 shows a perspective view of an embodiment of a safety switching arrangement.

FIG. 2 shows a cross-sectional view through a safety switch according to the embodiment of FIG. 1.

FIG. 3 shows a further cross-sectional view through the embodiment of the safety switching arrangement according to FIG. 1.

### DETAILED DESCRIPTION

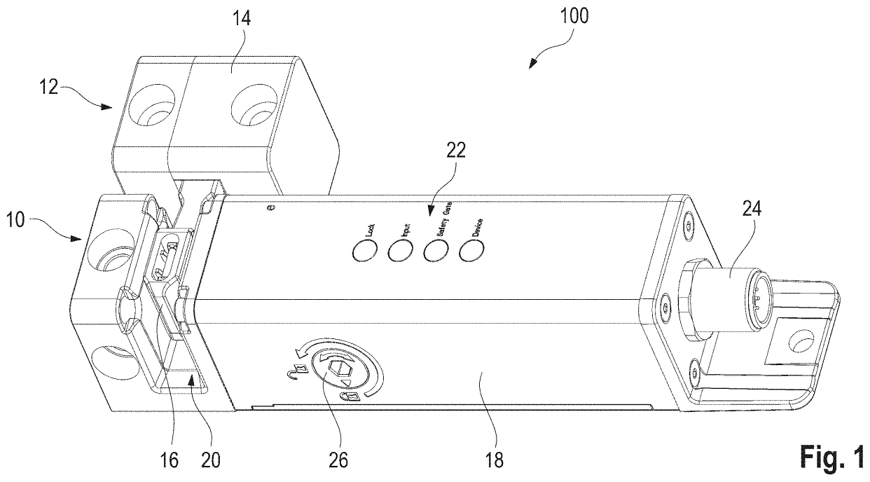

FIG. 1 shows a perspective view of an embodiment of a safety switching arrangement. The safety switching arrangement is designated here in its entirety by reference numeral 100 and essentially comprises two mutually movable, interacting components, namely a safety switch 10 and an actuator 12.

The actuator 12 comprises a mounting part 14, via which the actuator 12 can be connected to a safety-relevant, movable component, for example a safety door, and an actuator part 16, which can be brought into operative connection with the safety switch 10 based on a position of the safety-relevant, movable component.

The safety switch 10 comprises a housing with a base body 18 that can be fastened to a device, for example a door frame, which is fixed relative to the safety-relevant, movable component and has a receptacle 20 into which the actuator part 16 of the actuator 12 can be inserted in order to establish the operative connection.

The operative connection can include interlock monitoring as well as guard locking. A state of the operative connection can be visualized via display elements 22 on the base body 18. Furthermore, the state can be reported to other devices, particularly a safety controller, via an interface 24 to trigger a response depending on the state detected by the safety switch 10. For example, a safety controller can stop the operation of a technical installation if the actuator part 16 is not properly detected in the receptacle 20.

In the embodiment shown in FIG. 1, the safety switch 10 further comprises an auxiliary unlocking device 26 enabling an auxiliary or emergency unlocking of the actuator 12. As will be explained in more detail below, the auxiliary unlocking device 26 can be used to manually release a guard locking by the safety switch 10.

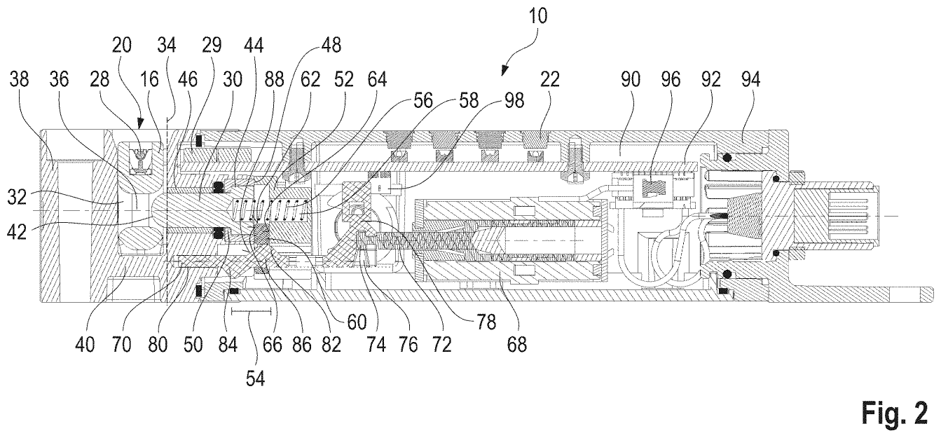

Referring to FIG. 2, an example structure of the safety switch 10 is explained in more detail below. FIG. 2 shows a cross-sectional view of the safety switch 10 of FIG. 1 longitudinally through the base body 18. Equal reference numerals indicate the same parts as in reference to FIG. 1.

In FIG. 2, as already shown with reference to FIG. 1, the actuator 12 is in the defined locking position with respect to the safety switch 10 in which the actuator part 16 is positioned in the receptacle 20 of the safety switch 10 in such a way that proper locking of the safety-related movable component with respect to the fixed component to which the safety switch 10 is attached can be assumed. The proper position of the actuator part 16 in the receptacle 20 can be determined, for example, as indicated here, via a transponder 28 in the actuator part 16 and a corresponding reader 29 in the safety switch 10. However, it shall be noted that the safety switch 10 is not limited to this design of interlock monitoring and other ways of determining the position of the actuator part relative to the safety switch 10 are conceivable.

In the defined locking position, the actuator part 16 can be locked in the receptacle 20 by the safety switch 10 so that the safety-relevant, movable component can no longer be moved in relation to the fixed component (guard locking). For this purpose, the safety switch 10 has a movably mounted locking bolt 30 that can engage the actuator part 16. For example, the actuator part 16 may have a recess 32 in the form of a hole, as shown here, or in the form of an engagement recess in which the locking bolt 30 engages to fix the actuator part 16. Simple engagement is sufficient for fixing, and there is no need to engage behind the actuator part 16.

Using a locking bolt 30 in the manner described for fixing allows the actuator part 16 to be fed to the safety switch 10 at any angle radially to the locking bolt 30 and to fix it in place. For example, the receptacle 20 may have a slot-like form, as shown here, with a 180° wide opening angle for receiving the actuator part 16. The receptacle 20 may be formed, for example, by a closing surface 34 extending orthogonally to a longitudinal body axis 36 of the bolt, a stop 38 opposite the bolt 30, and a crosspiece 40 connecting the stop 38 to the base body 18. Alternatively, a two-part receptacle 20 is conceivable, in which the stop 38 is detached from the base body 18. In this case, it would be conceivable to feed the actuator part 16 at a 360° angle radially to the locking bolt 30.

As shown here, the locking bolt 30 may be a cylindrical body having a rounded head part 42 and terminating in a radially projecting flange part 44 on a side opposite the head part 42. The locking bolt 30 may be movably mounted in a guide 46 along its longitudinal body axis 36. The locking bolt 30 is movable between a locking position, in which the locking bolt 30 projects into the closing surface 34, and a release position, in which the locking bolt 30 releases the actuator part 16. The flange part 44 can be disposed in a hollow cylindrical guide body 48, wherein an upper stop 50 and a lower stop 52 of the guide body 48 define a path of movement 54 along which the locking bolt 30 is movable between the two positions.

A recoil spring 56 (actuator) biases the locking bolt for movement into the locking position. The flange part 44 and the guide body 48 may each include respective opposing holes 58 for receiving and supporting the recoil spring 56. The recoil spring 56 may be configured to exert a force on the locking bolt 30 sufficient to pre-center the actuator part 16, but not block it such that movement of the actuator part out of the locked position is no longer possible. Rather, an actuating force of the recoil spring 56 may be selected to allow a person to pull the pre-centered actuator part 16 out of the receptacle 20 with normal force. This can be further facilitated by rounding the head part of the locking bolt 30 and/or by rounding the recess 32 in the actuator part 16 accordingly. When the actuator part 16 is moved in and out, the locking bolt 30, which is preloaded (biased) in the locking position, is thus moved against the actuating force of the recoil spring 56.

The safety switch 10 further comprises a locking bulkhead 60, which is arranged to fix the movably mounted locking bolt 30 at least in its locking position. The locking bulkhead 60 may be a rapidly displaceable shutter that is insertable into the path of movement 54 of the locking bolt 30 transversely, particularly perpendicularly, to the longitudinal body axis 36 of the locking bolt 30. For example, the locking bulkhead 60 may be insertable into the guide body 48 through a radial recess 62 therein to assume a first position (locking position).

In the locking position, the locking bulkhead 60 blocks movement of the locking bolt 30 via a positive fit. The positive fit may be formed by the engagement of the locking bulkhead 60 with the flange part 44 and a stop surface 64 of the guide body 48. A force pressing longitudinally on the locking bolt 30 against the actuating force of the recoil spring 56 acts here normal to a locking surface 66 of the locking bulkhead 60, with a surface opposite the locking surface 66 abutting an abutment surface 64 of the guide body 48. The guide body 48, which absorbs a force acting on the locking bolt 30 via the locking bulkhead 60, may be fixedly mounted in the base body 18 and is thus rigidly connected to the component to which the housing together with the base body 18 is attached.

In the second position (release position), movement of the locking bolt 30 is released, allowing it to move within the guide body 48 along the longitudinal body axis 36. When the locking bulkhead 60 is in the release position, the actuator part 16 can be pulled out of the receptacle 20, pushing the locking bolt 30 against the recoil spring's actuating force.

As shown in FIG. 2, the locking bulkhead 60 can lock the locking bolt 30 in the locking position. In various embodiments, the locking bulkhead 60 may additionally also hold the locking bolt 30 in a release position, i.e., in a position in which the locking bolt 30 does not protrude through the closing surface 34. For this purpose, the locking bolt 30 and the locking bulkhead 60 may be arranged such that the locking bulkhead 60 engages the flange part 44 to hold the locking bolt 30 against the actuating force of the recoil spring 56. Again, the locking bulkhead 60 may cooperate with the guide body 48 such that a force on the locking bolt 30 caused by the actuating force is resisted by a positive fit.

The locking bulkhead 60 is movable transversely, particularly perpendicularly, to the longitudinal body axis 36 of the locking bolt 30. A driving force for a movement of the locking bulkhead 60 may be provided by a drive 68, which is coupled to the locking bulkhead 60 by means of a transfer element 70. The transfer element 70 may perform a linear movement driven by the drive 68 and transfer this movement to the locking bulkhead 60.

As indicated in FIG. 2, the drive 68 can be a linear solenoid, in particular a bistable linear solenoid, which can set a rod 72 in linear motion. Here, the rod 72 terminates in a radially projecting head part 74 that engages a receptacle 76 on a lower portion 68 of the transfer element 70 to transfer linear motion of the drive 68 to the transfer element 70.

Movement of the transfer element 70 may be substantially parallel to the longitudinal body axis 36 of the locking bolt 30. For movement, the transfer element 70 may be mounted in a guide 80 extending parallel to the guide body 48. Further, the transfer element 70 may move the locking bulkhead 60 transversely to the longitudinal body axis 36 of the locking bolt 30 to lock the same as described above.

The locking bulkhead 60 may be supported so as to be capable of movement solely along this transverse axis 82, with forces acting on the locking bulkhead 60 transverse to this axis being absorbed by the support. As shown in FIG. 2, with an appropriate bearing, the locking bolt 30, the locking bulkhead 60 and the transfer element 70 can be force-decoupled. The bearing of the locking bulkhead 60 may be implemented, for example, by the recess 62 in the guide body 48

To transfer motion from the transfer element 70 to the locking bulkhead 60, the transfer element 70 may include projections 84, 86 that extend transverse to the linear direction of motion of the transfer element 70. The projections 84, 86 may be in the form of rounded cams, for example, and may cooperate with the locking bulkhead 60 so that the latter selectively assumes the locking position or the release position when the transfer element is moved in the lateral direction. For example, the locking bulkhead 60 may include an opening 88 through which the transfer element 70 passes longitudinally, wherein the projections 84, 86 each move (deflect) the locking bulkhead 60 in the direction of extension of the projections.

A distance over which the locking bulkhead 60 is deflectable, i.e., the distance between the first position and the second position, may be very small and may be less than 5 mm, for example. In addition, the locking bulkhead 60 may be freely supported so that little force is required to move it from the first position to the second position. Accordingly, a small and very compact drive 68 may be sufficient to provide effective guard locking. Furthermore, since a force acting on the locking bolt 30 against the actuating force of the recoil spring 56 is not transferred to the actuator 68, the actuator 68 does not have to be designed to withstand such forces. Overall, the small size of the drive 68 and the simple locking mechanism allows the safety switch 10 to be very small and compact. Furthermore, the drive 68 requires only very little energy to provide effective guard locking according to the described configuration.

The safety switch 10 may have an auxiliary unlocking device 26 that provides an additional unlocking option, as shown in the present embodiment. The safety switch 10 can be manually unlocked via the auxiliary unlocking device 26 with the aid of a tool such as a wrench or a square wrench, for example.

In the embodiment shown here, the auxiliary unlocking device 26 is coupled to the transfer element 70 at the lower portion 78 thereof, wherein a rotational movement of the auxiliary unlocking device 26 is converted into the linear movement of the transfer element 70 described previously. The linear motion, in turn, moves the locking bulkhead 60 from the locking position to the release position in the manner previously described.

Since the drive 68 only has to be designed to apply a force for moving the locking bulkhead, but is otherwise force-decoupled from the locking bolt, the auxiliary release can be actuated directly against the driving force of the drive 68 in this configuration. In contrast to known safety switches, the guard locking described here via a locking bulkhead 60 thus enables a particularly simple design of an auxiliary and/or emergency release, since no additional decoupling from the drive 68 needs to be provided. Thereby, the design of the safety switch 10 can be further simplified.

Electronics 90 may be provided for interlock monitoring by the transponder/reader combination 28, 29, for visualization the state of the safety switch 10 by means of the display elements 22, and for control of the drive 68.

The electronics 90, which may include integrated and discrete components, are arranged here on a single printed circuit board 92. The printed circuit board 92 extends substantially in the longitudinal direction of the safety switch 10 directly along an upper surface 94 of the housing of the safety switch 10. This positioning has the advantage that all necessary electrical components of the safety switch 10 can be arranged on a single circuit board. The circuit board may comprise the reader 29, the display elements 22, a drive control 96 and a sensor system 98 for detecting the respective operating state of the guard locking.

The sensor system 98 may be a photoelectric sensor whose light beam is interrupted in response to the position of the transfer element 70.

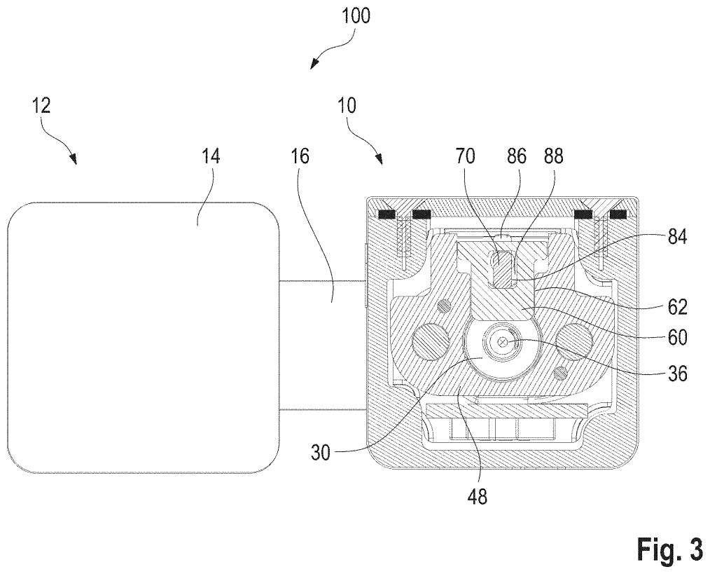

FIG. 3 shows a cross-sectional view of the previously described safety switching arrangement 100. Identical reference signs denote identical parts as previously shown in FIG. 1 and FIG. 2.

Here, the section plane is a normal plane to the longitudinal body axis 36 of the locking bolt 30 and passes through the locking bulkhead 60. As in the previous embodiments, the locking bulkhead 60 is in the locking position where movement of the locking bolt 30 is blocked. The locking bolt 30 is mounted in the guide body 48 such that the bolt 30 can move along its longitudinal body axis 36. The locking bulkhead 60 is movably mounted in a recess 62 of the guide body 48 and is movable transversely to the longitudinal axis 36. In this embodiment, the locking bulkhead 60 includes an opening 88 through which the transfer element 70 passes. The transfer element 70 is here movable parallel to the longitudinal body axis 36. In this regard, the projections 84 and 86 deflect the locking bulkhead 60 to either the locking position or the release position. Additional stops on the guide body 48 prevent the locking bulkhead from being inserted too far into the guide body 48.

It shall be noted that the locking bulkhead 60 is not limited to the form shown herein, but that other variations are conceivable as to how the locking bulkhead 60 may be configured. It is only required that the locking bulkhead 60 can engage with a path of movement of the locking bolt 30 in such a way that the latter is locked in its movement via a positive fit. The positive fit can be formed with the guide body 48. The phrase “at least one of A, B, and C” should be construed to mean a logical (A OR B OR C), using a non-exclusive logical OR, and should not be construed to mean “at least one of A, at least one of B, and at least one of C.”

Furthermore, the embodiment shown here is only to be understood as example and different embodiments are conceivable without leaving the scope of the present invention. In principle, the scope of protection of the present invention is determined by the following claims and is not limited by the features explained in the description or shown in the figures.

What is claimed is:

1. A safety switch comprising:
a movably mounted locking bolt configured to lock an actuator in a defined locking position relative to the safety switch; and
a movably mounted locking bulkhead movable between a first position and a second position, wherein the locking bulkhead is configured to fix the movably mounted locking bolt in the second position via a positive fit.

2. The safety switch of claim 1 further comprising:
a guide body having a recess, wherein:
the movably mounted locking bolt is mounted in the guide body, the locking bulkhead is movable into the guide body through the recess, and
the positive fit is formed between the locking bulkhead and the guide body.

3. The safety switch of claim 1 further comprising a transfer element configured to move the locking bulkhead transversely to a longitudinal direction of the transfer element from the first position to the second position upon a movement extending along the longitudinal direction of the transfer element.

4. The safety switch of claim 3 wherein the transfer element is configured to move the locking bulkhead perpendicularly to the longitudinal direction of the transfer element.

5. The safety switch of claim 3 wherein the transfer element includes:
a first projection that rises in a first direction transverse to the longitudinal direction of the transfer element; and
a second projection that rises in a second direction opposite the first direction and that is offset in the longitudinal direction of the transfer element relative to the first projection.

6. The safety switch of claim 1 further comprising a drive configured to move the locking bulkhead from the first position to the second position.

7. The safety switch of claim 6 wherein the drive is an electromechanical actuator and is configured to execute a first linear movement along a defined direction of movement.

8. The safety switch of claim 7 wherein the electromechanical actuator is a solenoid.

9. The safety switch of claim 7 wherein the movably mounted locking bolt is configured to perform a second linear movement along the defined direction of movement.

10. The safety switch of claim 6 wherein the movably mounted locking bolt and the drive are force-decoupled.

11. The safety switch of claim 1 further comprising an actuator element having an actuating force that biases the movably mounted locking bolt into a pre-centering position.

12. The safety switch of claim 1 further comprising:
an auxiliary unlocking device, wherein the locking bulkhead is movable from the first position to the second position by the auxiliary unlocking device.

13. The safety switch of claim 12 further comprising:
a drive configured to move the locking bulkhead from the first position to the second position, wherein:
the auxiliary unlocking device is kinematically coupled to the drive; and
the locking bulkhead is movable via the auxiliary unlocking device against a driving force of the drive.

14. The safety switch of claim 1 further comprising a reader configured to read signals from a corresponding transponder of the actuator when the actuator is in the defined locking position.

15. The safety switch of claim 1 further comprising an evaluation unit configured to:
detect at least one of a position of an actuator part of the actuator, a position of the locking bolt, and a position of the locking bulkhead; and
signal the detected position to a controller connected to the safety switch.

16. The safety switch of claim 15 wherein the evaluation unit is configured to perform the detection using at least one of direct detection and indirect detection.

17. The safety switch of claim 1 further comprising:
a receptacle into which an actuator part of the actuator is insertable to assume the defined locking position, wherein the receptacle has an opening angle of 180° at which the actuator part is insertable into the receptacle.

18. A safety switching arrangement comprising:
the safety switch of claim 1; and
an actuator movable relative to the safety switch.
